(19) United States
(12) Patent Application Publication
(10) Pub. No.: US 2015/0248148 A1
(43) Pub. Date: Sep. 3, 2015

(54) AIR DUCT, COOLING MODULE, AND ELECTRONIC DEVICE

(71) Applicants: HONG FU JIN PRECISION INDUSTRY (WuHan) CO., LTD., Wuhan (CN); HON HAI PRECISION INDUSTRY CO., LTD., New Taipei (TW)

(72) Inventors: ZAN LI, Wuhan (CN); LIANG-CHIN WANG, New Taipei (TW); YU-MING XIAO, Wuhan (CN); CUI-GUO WANG, Wuhan (CN)

(21) Appl. No.: 14/540,262

(22) Filed: Nov. 13, 2014

(30) Foreign Application Priority Data
Feb. 28, 2014 (CN) 201410069872.3

(51) Int. Cl. G06F 1/20; G06F 1/18; F24F 7/007

(52) U.S. Cl. CPC G06F 1/20; F24F 7/007; G06F 1/184; G06F 1/185

(57) ABSTRACT

An air duct includes a base and a latching portion extending from the base. The base includes a resilient portion and two blocking plates. The latching portion is configured to receive a fan. The resilient portion is elastic deformable to fasten the base to the fan. The latching portion defines a ventilation hole for air flowing through in a first direction. The two blocking plates are configured to prevent the air from flowing back to the ventilation hole in a second direction opposite to the first direction. A cooling module with the air duct and an electronic device with the air duct are further disclosed.

### FIELD

The subject matter herein generally relates to an electronic device with a cooling module with an air duct.

### BACKGROUND

An electronic device, such as a computer, generally includes an enclosure, a central processing unit (CPU), a heat sink, and a fan. The heat sink cools the CPU, and the fan is operated to guide air to flow to the heat sink to cool the heat sink.

### BRIEF DESCRIPTION OF THE DRAWINGS

Implementations of the present technology will now be described, by way of example only, with reference to the attached figures.

FIG. 1 is an exploded, isometric view of an embodiment of an air duct and a cooling module.

FIG. 2 is an isometric view of the air duct and the cooling module of FIG. 1.

FIG. 3 is an assembled, isometric view of the air duct and the cooling module of FIG. 1.

FIG. 4 is similar to FIG. 3, but viewed from a different angle.

FIG. 5 is an assembled, isometric view of within an enclosure of an electronic device.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising,” when utilized, means “including, but not necessarily limited to”; it specifically indicates open-ended inclusion or membership in the so-described combination, group, series and the like.

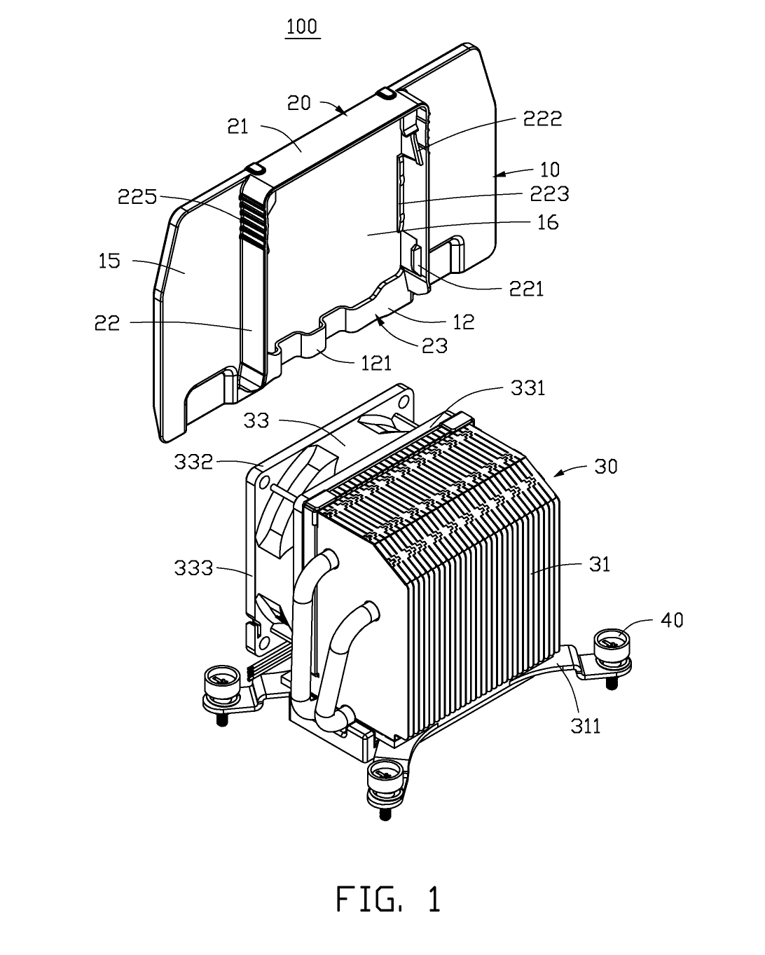

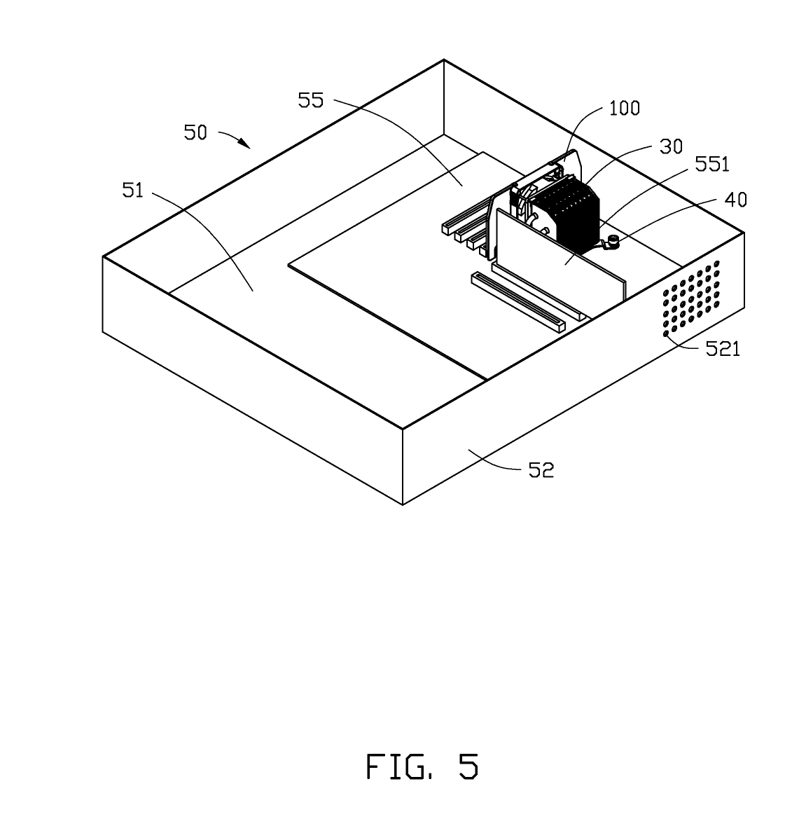

FIG. 1 illustrates an electronic device with an air duct in accordance with an embodiment. The air duct 100 can guide air to flow in a cooling module 30. The cooling module 30 can be secured to an enclosure 50 (shown as in FIG. 5) of the electronic device.

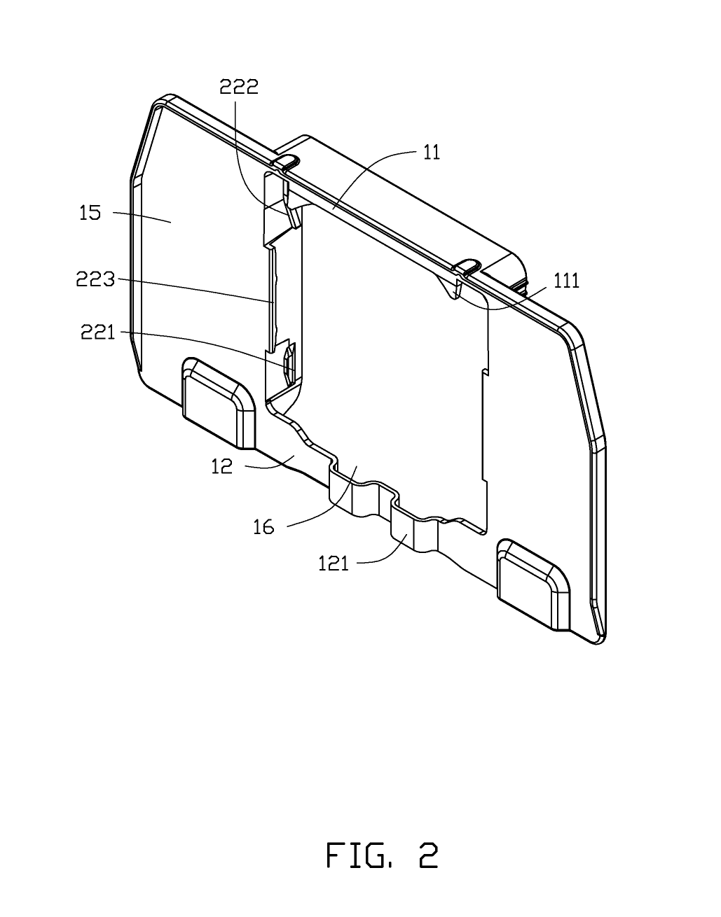

FIGS. 1 and 2 illustrate that the air duct 100 can include a base 10 and a latching portion 20 extending from the base 10. The base 10 can include a first connecting plate 11, a second connecting plate 12, and two blocking plates 15. The first connecting plate 11 is substantially parallel to the second connecting plate 12. The first connecting plate 11 and the second connecting plate 12 are connected between the two blocking plates 15. The first connecting plate 11, the second connecting plate 12, and the two blocking plates 15 cooperatively define a ventilation hole 16. Two mounting tabs 111 extend from opposite ends of the first connecting plate 11. A resilient portion 121 can be pressed from the second connecting plate 12.

The latching portion 20 can include a top plate 21 and two limiting plates 22 extending from opposite edges of the top plate 21. In at least one embodiment, the top plate 21 is substantially perpendicular to the first connecting plate 11 and the limiting plates 22, and each limiting plate 22 is substantially perpendicular to the first connecting plate 11. A cutout 23 is defined between the two limiting plates 22 away from the first connecting plate 11, allowing the air duct 100 to be secured to the cooling module 30. Each limiting plate 22 comprises a first guiding piece 221 away from the top plate 21, a second guiding piece 222 adjacent to the top plate 21, and a third guiding piece 223 between the first guiding piece 221 and the second guiding piece 222. The third guiding piece 223 is near to the base 10 relative to the first guiding piece 221 and the second guiding piece 222. Each of the first guiding piece 221, the second guiding piece 222, and the third guiding piece 223 extends towards the ventilation hole 16. An operation portion 225 is located in an outer surface of each limiting plate 22.

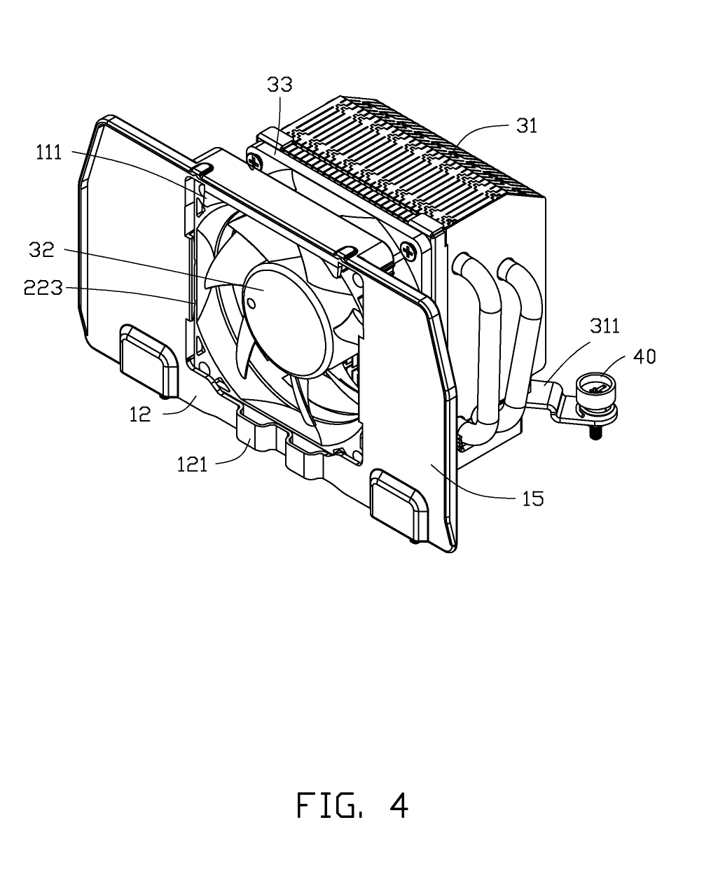

Referring to FIG. 1, the cooling module 30 can include a heat sink 31, a fan 32 (shown as in FIG. 4), and a fan case 33. The heat sink 31 can include four installation portions 311. A fastener 40 can be inserted through the installation portions 311 to secure the heat sink 31 to a motherboard 55 (shown as in FIG. 5). The fan 32 is secured to the fan case 33 and is operable to guide air to flow to the heat sink 31.

The fan case 33 can include a rear frame 331 and a front frame 332. The rear frame 331 can be secured to the heat sink 31, and the air duct 100 can be secured to the front frame 332. A distance between the two limiting plates 22 is smaller than a width of the front frame 332.

FIG. 5 illustrates that the enclosure 50 can include a bottom plate 51 and four side plates 52 extending from four edges of the bottom plate 51. The motherboard 55 is secured to the bottom plate 51. A plurality of expansion cards 551, such as graphics cards, is attached to the motherboard 55. The side plate 52, facing the heat sink 31, defines a plurality of air outlets 521 for air flowing out of the enclosure 50.

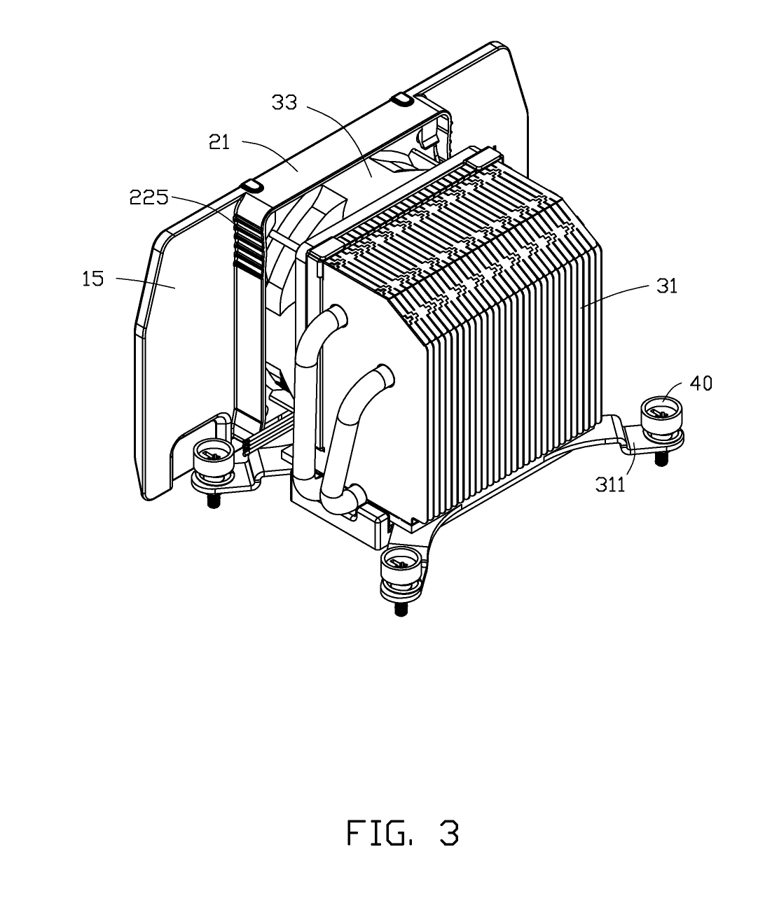

Referring to FIGS. 3-5, during assembly, the fan 32 is secured to the fan case 33, the rear frame 331 is secured to the heat sink 31, and thus the cooling module 30 is assembled. The cooling module 30 is moved to contact the heat sink 31 to a heating component (not shown), and the fasteners 40 are secured to the motherboard 55 via the installation portions 311 to secure the cooling module 30 to the motherboard 55. The cutout 23 is aligned to the front frame 332. The air duct 100 is pressed towards the motherboard 55, the resilient portion 121 is elastically deformed to allow the front frame 332 to move between the two limiting plates 22. When the front frame 332 abuts the top plate 21, the air duct 100 is released. The first guiding piece 221 and the second guiding piece 332 abut a rear surface of the front frame 332 between the front frame 332 and the rear frame 331, the third guiding piece 333 and the mounting tabs 111 abut a front surface of the front frame 332, and the resilient portions 121 exert elastic force to secure the air duct 100 to the front frame 332. One of the two blocking plates 15 abuts the side plate 52 and is substantially perpendicular to the side plate 52, and each expansion card 551 is located between the other one of the two blocking plates 15 and the side plate 52, preventing air from flowing back to the ventilation hole 16 by the fan 32, so that air from the cooling module 30 flows out of the enclosure 50 via the air outlets 521.

In disassembly, the operation portions 225 can be pressed to pull the air duct 100 away from the motherboard 55 to remove the air duct 100 from the cooling module 30.

Referring to FIG. 5, in operation, the fan 32 guides air to flow from the ventilation hole 16 into the cooling module 30 and then flow out of the enclosure 50 via the air outlets 521. The blocking plates 15 prevent air from flowing back to the ventilation hole 16 by the fan 32.

The embodiments shown and described above are only examples. Many details are often found in the art such as the other features of an air duct, cooling module, and electronic device. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims. It will therefore be appreciated that the embodiments described above may be modified within the scope of the claims.

What is claimed is:

1. An air duct comprising:
base comprising a resilient portion and two blocking plates; and
a latching portion extending from the base and configured to receive a fan and defining a ventilation hole for air flowing through in a first direction;
wherein the resilient portion is elastic deformable to fasten the base to the fan, and the two blocking plates are configured to prevent the air from flowing back to the ventilation hole in a second direction opposite to the first direction.

2. The air duct of claim 1, wherein the base further comprises a first connecting plate connected between the two blocking plates and two mounting tabs extending from the first connecting plate, and the two mounting tabs are configured to secure the fan.

3. The air duct of claim 2, wherein the base further comprises a second connecting plate connected between the two blocking plates, the first connecting plate is substantially parallel to the second connecting plate, and the resilient portion extends from the second connecting plate.

4. The air duct of claim 3, wherein the first connecting plate, the second connecting plate, and the two blocking plates cooperatively define the ventilation hole.

5. The air duct of claim 1, wherein the latching portion comprises a top plate and two limiting plates extending from opposite edges of the top plate, and a cutout is defined between the two limiting plates away from the top plate.

6. The air duct of claim 5, wherein the latching portion further comprises a first guiding piece, a second guiding piece, and a third guiding piece extending from each limiting plate configured to secure the fan, and the third guiding piece is near the ventilation hole relative to the first guiding piece and the second guiding piece.

7. The air duct of claim 5, wherein the top plate is substantially perpendicular to each blocking plate, and each limiting plate is substantially perpendicular to the top plate and each limiting plate.

8. An electronic device comprising:
an enclosure comprising a first side plate and a second side plate substantially perpendicular to the first side plate;
a motherboard secured to the enclosure with an expansion card; and
a cooling module comprising:
a heat sink configured to cool a heating component;
a fan secured to the heat sink; and
air duct comprising:
a base comprising a resilient portion and two blocking plates; and
a latching portion extending from the base and configured to receive the fan and defining a ventilation hole for air flowing through in a first direction;
wherein the resilient portion is elastic deformable to fasten the base to the fan; one of the two blocking plates abuts the first side plate and substantially perpendicular to the first side plate, the expansion card is located between the other one of the two blocking plates and the second side plate, preventing the air from flowing back to the ventilation hole in a second direction opposite to the first direction.

9. The electronic device of claim 8, wherein the base further comprises a first connecting plate connected between the two blocking plates and two mounting tabs extending from the first connecting plate, and the two mounting tabs are configured to secure the fan.

10. The electronic device of claim 9, wherein the base further comprises a second connecting plate connected between the two blocking plates, the first connecting plate is substantially parallel to the second connecting plate, and the resilient portion extends from the second connecting plate.

11. The electronic device of claim 10, wherein the first connecting plate, the second connecting plate, and the two blocking plates cooperatively define the ventilation hole.

12. The electronic device of claim 8, wherein the latching portion comprises a top plate and two limiting plates extending from opposite edges of the top plate, and a cutout is defined between the two limiting plates away from the top plate.

13. The electronic device of claim 12, wherein the latching portion further comprises a first guiding piece, a second guiding piece, and a third guiding piece extending from each limiting plate configured to secure the fan, and the third guiding piece is near the ventilation hole relative to the first guiding piece and the second guiding piece.

14. The electronic device of claim 12, wherein the top plate is substantially perpendicular to each blocking plate, and each limiting plate is substantially perpendicular to the top plate and each limiting plate.

15. A cooling module comprising:
a heat sink configured to cool a heating component;
a fan secured to the heat sink; and
an air duct comprising:
a base comprising a resilient portion and two blocking plates; and
a latching portion extending from the base and configured to receive the fan and defining a ventilation hole for air flowing through in a first direction;
wherein the resilient portion is elastic deformable to fasten the base to the fan; and the two blocking plates are configured to prevent the air from flowing back to the ventilation hole in a second direction opposite to the first direction.

16. The cooling module of claim 15, wherein the base further comprises a first connecting plate connected between the two blocking plates and two mounting tabs extending from the first connecting plate, and the two mounting tabs are configured to secure the fan.

17. The cooling module of claim 16, wherein the base further comprises a second connecting plate connected between the two blocking plates, the first connecting plate is substantially parallel to the second connecting plate, and the resilient portion extends from the second connecting plate.

18. The cooling module of claim 17, wherein the first connecting plate, the second connecting plate, and the two blocking plates cooperatively define the ventilation hole.

19. The cooling module of claim 17, wherein the latching portion comprises a top plate and two limiting plates extending from opposite edges of the top plate, and a cutout is defined between the two limiting plates away from the top plate.

20. The cooling module of claim 19, wherein the latching portion further comprises a first guiding piece, a second guiding piece, and a third guiding piece extending from each limiting plate configured to secure the fan, and the third guiding piece is near the ventilation hole relative to the first guiding piece and the second guiding piece.
